(19) United States
(12) Patent Application Publication
(10) Pub. No.: US 2026/0237584 A1
(43) Pub. Date: Aug. 13, 2026

(54) RESETABLE SOLID-STATE FUSE

(71) Applicant: Kyocera AVX Components (Salzburg) GmbH, Salzburg (AT)

(72) Inventors: Sebastian Rohm, Salzburg (AT); Riku Harju-Säntti, Salzburg (AT); Wolfgang Tusler, Salzburg (AT); Christian Schaidreiter, Salzburg (AT); Gellert Balogh, Oberndorf (AT); Daniel Lebeiner, Freilassing (DE)

(21) Appl. No.: 19/535,652

(22) Filed: Feb. 10, 2026

Related U.S. Application Data
(60) Provisional application No. 63/757,515, filed on Feb. 12, 2025.

(51) Int. Cl. H01H 85/02; G06F 1/26; H01H 85/046; H01H 85/055; H01H 85/10; H01H 85/20; H01H 85/30; H01H 85/32; H02H 3/00; H02M 7/537

(52) U.S. Cl. CPC H01H 85/0241; G06F 1/26; H01H 85/046; H01H 85/055; H01H 85/10; H01H 85/20; H01H 85/30; H01H 85/32; H02H 3/006; H02M 7/537; H01H 2085/0283

(57) ABSTRACT

A method for controlling one or more solid-state switching devices of at least one solid-state fuse to disconnect one or more first components of a power system from one or more second components of the power system is provided. The method includes measuring a voltage across a bus of the at least one solid-state fuse. The method further includes determining a current slope signal indicative of a current slope of a system current flowing through the power system based at least in part on the voltage across the bus. The method further includes controlling, by a controller of the at least one solid-state fuse, the one or more solid-state switching devices to bidirectionally or unidirectionally disconnect the one or more first components from the one or more second components of the power system based at least in part on the current slope signal.

### PRIORITY CLAIM

The present application is based on and claims priority to U.S. Provisional Patent Application No. 63/757,515, titled “RESETTABLE SOLID-STATE FUSE,” filed on Feb. 12, 2025, which is incorporated herein by reference.

### FIELD

Aspects of the present disclosure relate generally to a solid-state fuse, and more specifically to a resettable solid-state fuse for use in high-power applications.

### BACKGROUND

Solid-state fuses can be used in various electrical switching applications. Solid-state fuses can include one or more solid-state switching device(s) (e.g., FETs, IGBTs, etc.). For instance, a solid-state fuse can include one or more solid-state switching device(s) arranged to implement a bidirectional switch, an inverter bridge, etc.

### SUMMARY

Aspects and advantages of embodiments of the present disclosure will be set forth in part in the following description, or can be learned from the description, or can be learned through practice of the embodiments.

One example aspect of the present disclosure is directed to a method for controlling one or more solid-state switching devices of at least one solid-state fuse to disconnect one or more first components of a power system from one or more second components of the power system. The method includes measuring a voltage across a bus of the at least one solid-state fuse. The method further includes determining a current slope signal indicative of a current slope of a system current flowing through the power system based at least in part on the voltage across the bus. The method further includes controlling, by a controller of the at least one solid-state fuse, the one or more solid-state switching devices to bidirectionally or unidirectionally disconnect the one or more first components from the one or more second components of the power system based at least in part on the current slope signal.

Another example aspect of the present disclosure is directed to a solid-state fuse. The solid-state fuse includes a first power terminal operable to couple the solid-state fuse to one or more first components of a power system. The solid-state fuse further includes a second power terminal operable to couple the solid-state fuse to one or more second components of the power system. The solid-state fuse further includes one or more solid-state switching devices operable to disconnect the first power terminal from the second power terminal. The solid-state fuse further includes a bus operable to conduct at least a portion of a system current, the system current indicative of a current flowing through the power system. The solid-state fuse further includes a bus measurement circuit coupled to the bus, the bus measurement circuit configured to measure a voltage across the bus. The solid-state fuse further includes a controller. The controller is configured to determine a current slope signal indicative of a current slope of the system current based at least in part on the voltage across the bus. The controller is further configured to control the one or more solid-state switching devices to bidirectionally or unidirectionally disconnect the first power terminal from the second power terminal based at least in part on the current slope signal.

Another example aspect of the present disclosure is directed to a power system. The power system includes one or more first components. The power system further includes one or more second components. The power system further includes at least one solid-state fuse coupled between the one or more first components and the one or more second components. The at least one solid-state fuse includes a first power terminal operable to couple the solid-state fuse to the one or more first components. The at least one solid state fuse further includes a second power terminal operable to couple the solid-state fuse to the one or more second components. The at least one solid state fuse further includes one or more solid-state switching devices operable to disconnect the first power terminal from the second power terminal The at least one solid state fuse further includes a bus operable to conduct at least a portion of a system current, the system current indicative of a current flowing through the power system The at least one solid state fuse further includes a bus measurement circuit coupled to the bus, the bus measurement circuit configured to measure a voltage across the bus The at least one solid state fuse further includes a controller. The controller is configured to determine a current slope signal indicative of a current slope of the system current based at least in part on the voltage across the bus. The controller is further configured to control the one or more solid-state switching devices to bidirectionally or unidirectionally disconnect the first power terminal from the second power terminal based at least in part on the current slope.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 provides a schematic implementation of a solid-state fuse according to example embodiments of the present disclosure;

FIG. 2 provides another schematic implementation of a solid-state fuse according to example embodiments of the present disclosure;

FIG. 3 provides another schematic implementation of a solid-state fuse according to example embodiments of the present disclosure;

FIG. 4 illustrates a top-down view of an example printed circuit board (PCB) bus system according to example embodiments of the present disclosure;

FIG. 5 illustrates a top-down view of an example busbar of the PCB bus system provided in FIG. 4;

FIG. 6A depicts a schematic implementation of an example power system according to example embodiments of the present disclosure;

FIG. 6B depicts another schematic implementation of an example power system according to example embodiments of the present disclosure;

FIG. 7 provides a block diagram of an example controller according to example embodiments of the present disclosure;

FIG. 8 provides a plot depicting an example interruption provided by a solid-state fuse according to example embodiments of the present disclosure;

FIG. 9 provides a plot depicting example signals of a solid-state fuse according to example embodiments of the present disclosure; and

FIG. 10 provides an example method for controlling one or more solid-state switching devices of at least one solid-state fuse according to example embodiments of the present disclosure.

Repeat use of reference characters in the present specification and drawings is intended to represent same or analogous features or elements.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value refers to a value that falls within 15% of the stated numerical value.

As used herein, the phrase “high-power” may include a voltage level in a range of about 12 volts [V] to about 1,700 [V] and/or a current level in a range of about 50 Amperes [A] to about 2,000 [A].

A solid-state fuse may be coupled between one or more first components and one or more second components of a power system (e.g., high-power system), such that the solid-state fuse may control the flow of electricity through the system by connecting/disconnecting the one or more first components from the one or more second components. The solid-state fuse may be configured to trigger an interruption to disconnect the components when a short circuit event occurs. As such, fast detection of the short circuit and switching speed may be important as a current supplied during a short circuit event may damage or destroy system components before the switch can interrupt the current. A solid state fuse may include one or more solid state components, such as one or more semiconductor-based components.

Example aspects of the present disclosure are directed to a solid-state fuse. The solid-state fuse may include one or more resettable solid-state switching devices configured to disconnect high-power direct current (DC) using an internal trigger. The internal trigger may provide for fast and reliable short circuit detection while the solid-state relays may provide for faster switching speeds when compared to other switching devices such as a conventional mechanical fuse.

Aspects of the present disclosure provide a number of technical effects and benefits. For instance, the solid-state fuse of the present disclosure may provide for reliable disconnection during an overcurrent event such as a short circuit event. In addition, trigger methods provided by the present disclosure may provide for a fast and accurate overcurrent detection during an overcurrent event such as a short circuit.

The solid-state fuse of the present disclosure may include a bus (e.g., busbar), such as a copper bus positioned within (e.g., coupled between) the one or more solid-state switching devices of the solid-state fuse. The bus is operable to conduct at least a portion of a current flowing through a power system. For instance, the whole system current or part of the system current may be provided on the bus. A voltage across the bus may be measured by, for instance, a pair of voltage tabs placed at both ends of the bus. The solid-state fuse may further include a controller (e.g., internal controller) configured to determine a current slope (di/dt) of the system based at least in part on the voltage across the bus and one or more electrical characteristics of the bus.

For instance, a DC source coupled to the solid-state fuse may have a defined inductance (L_{system}) during normal operation due to, for instance, cables and/or consumers of the power system. As such, the current slope (di/dt) may have a maximum threshold value while the system is in normal operation as reflected in the equation below:

$$V = \frac{di}{dt} * {L}_{System}$$

However, during a short circuit event, the system inductance (L_{system}) may drop significantly to values in the microhenry [ρH] range, such as to a value in a range from about 1 μH to about 2 μH. As shown in the equation above, the current slope (di/dt) may increase quickly during a short circuit event due to the significant drop in the system inductance (L_{system}).

Accordingly, aspects of the present disclosure provide for an interruption trigger method based on a defined inductance of the bus. As previously described, the bus may be positioned within the resettable solid-state component of the solid-state fuse. The bus is operable to conduct at least a portion of a current flowing through a power system. As such, a voltage-drop (e.g., voltage) across the bus (V_{bus}) may be defined by the equation below:

$${V}_{b u s} = \frac{di}{dt} * {L}_{b u s} + {R}_{b u s} * I$$

As shown above, the current slope (di/dt) may be determined (e.g., estimated) based on the voltage across the bus (V_{bus}) and one or more electrical characteristics (e.g., known electrical characteristics) of the bus such as the resistance (R_{bus}) and/or inductance of the bus (L_{bus}). Specifically, the inductance of the bus (L_{bus}) may have a pre-determined, known value. Additionally or alternatively, the resistance of the bus (R_{bus}) may be relatively small such that the voltage across the bus (V_{bus}) depends primarily on the current slope (di/dt). For instance, the inductance of the bus (L_{bus}) may be about 10 nH and the resistance of the bus (R_{bus}) may be such that the current slope (di/dt) of the system may be accurately determined from the voltage across the bus (V_{bus}). In some embodiments, the resistance of the bus (R_{bus}) may be in a range of about 0.1 microohms to about 200 microohms, such as in a range of about 0.1 microohms to about 50 microohms, such as about 10 microohms. Additionally and/or alternatively, the inductance of bus (L_{bus}) may be in a range of about 0.1 nanohenrys (nH) to about 50 nanohenrys, such as about 10 nanohenrys.

In the event of a short circuit, a voltage step may be registered quickly and thereby the system may be shut down before current reaches a level that may harm components of the system.

Referring now to the figures, example aspects of the present disclosure will be discussed in greater detail.

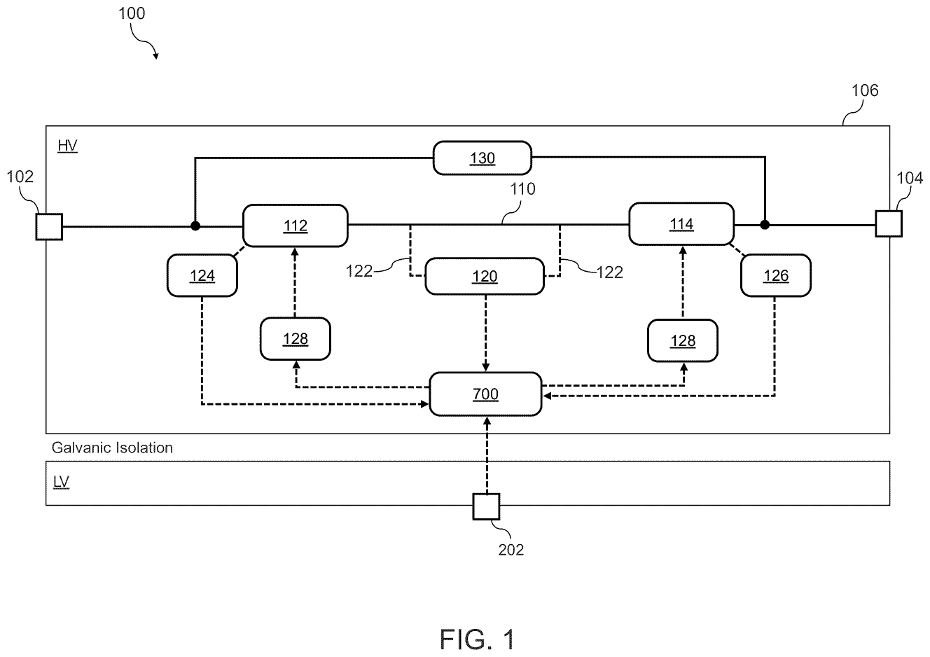

FIG. 1 provides a schematic implementation of a solid-state fuse 100 according to example embodiments of the present disclosure. Solid-state fuse 100 is a resettable solid-state fuse having a first power terminal 102 and a second power terminal 104. The solid-state fuse 100 may be implemented within a power system, such as a high-power system, to connect/disconnect one or more first components of the power system from one or more second components of the power system. For example, first power terminal 102 may be coupled to the one or more first components of a power system and second power terminal 104 may be coupled to one or more second components of a power system. Solid-state fuse 100 may be a bidirectional fuse configured to control the flow of electricity in both directions (e.g., from first power terminal 102 to second power terminal 104, from second power terminal 104 to first power terminal 102). As such, the solid-state fuse 100 may bidirectionally disconnect the first power terminal 102 from the second power terminal 104 such that electricity may not flow in either direction (e.g., from first power terminal 102 to second power terminal 104, from second power terminal 104 to first power terminal 102). Additionally and/or alternatively, solid-state fuse 100 may be configured to unidirectionally disconnect the first power terminal 102 from the second power terminal 104 such that electricity may not flow in a first direction (e.g., from the first power terminal 102 to the second power terminal 104) or unidirectionally disconnect the second power terminal 104 from the first power terminal 102 such that electricity may not flow in a second direction opposite the first direction (e.g., from the second power terminal 104 to the first power terminal 102). In some embodiments, the power system may be a power system of an electric vehicle.

Solid-state fuse 100 may include one or more solid-state switching devices 112, 114. While two solid-state switching devices 112, 114 are depicted in FIG. 1, those of ordinary skill in the art will understand that any suitable number of solid-state switching devices may be used without deviating from the scope of the present disclosure. Solid-state switching devices 112, 114 may each include one or more power semiconductor device, such as a SiC-FET, GaN-FET, Si-MOSFET, IGBT, etc. For instance, each solid-state switching device 112, 114 may include a singular power semiconductor device. In alternative embodiments, each solid state switching device 112, 114 may include a plurality of power semiconductor devices in a parallel configuration. By configuring the power semiconductor devices in parallel, the current capability of the solid-state fuse 100 may be increased. Solid-state switching devices 112, 114 may be configured in a bidirectional manner such that the solid-state switching devices 112, 114 may adjust the flow of electricity in both directions (e.g., from first power terminal 102 to second power terminal 104, from second power terminal 104 to first power terminal 102). For instance, solid-state fuse 100 may bidirectionally disconnect the first power terminal 102 from the second power terminal 104 using switching devices 112, 114 such that electricity may not flow from the first power terminal 102 to the second power terminal 104 or from the second power terminal 104 to the first power terminal 102.

As shown in FIG. 1, solid-state fuse 100 may further include a bus 110. Bus 110 may be coupled between a first solid-state switching device 112 and a second solid-state switching device 114. For instance, bus 110 may couple the first solid-state switching device 112 to the second solid-state switching device 114. While bus 110 is illustrated in FIG. 1 as being coupled between a first solid-state switching device 112 and a second solid-state switching device 114, those of ordinary skill in the art will understand that this is done for purposes of illustration and discussion and that bus 110 may be located at other suitable positions within the solid-state fuse 100 (e.g., within housing 106 of solid-state fuse 100). When the first power terminal 102 and the second power terminal 104 are connected, bus 110 may be operable to conduct at least a portion of the system current. Bus 110 may be any suitable type of bus (e.g., busbar) with a known inductance. As current is flowing over the bus 110, a voltage drop may be generated. In some embodiments, the resistance of the bus 110 may be in a range of about 0.1 microohms to about 200 microohms, such as in a range of about 0.1 microohms to about 50 microohms, such as about 10 microohms. Additionally and/or alternatively, the inductance of bus 110 may be in a range of about 0.1 nanohenrys (nH) to about 50 nanohenrys, such as about 10 nanohenrys. In some embodiments, solid-state fuse 100 may include a printed circuit board (PCB) bus system, such as a PCB bus system disclosed below. For instance, bus 110 may be a busbar, such as a copper busbar (e.g., Cu-busbar) coupled to a printed circuit board (PCB).

Solid-state fuse 100 may further include a bus measurement circuit 120 configured to measure a voltage across the bus 110. As shown, bus measurement circuit 120 may be coupled to the bus 110. In some embodiments, bus measurement circuit 120 may include a pair of bond wires coupled to the bus 110 via voltage tabs 122. Each voltage tab 122 may be positioned on an end of the bus 110 such that a voltage-drop across the bus 110 may be measured. For instance, all current flowing through a power system may flow over the bus 110 (e.g., busbar). As such, the voltage-drop across the bus 110 may indicate a voltage-drop in the power system. Bus measurement circuit 120 may further include an amplifier circuit configured to determine the voltage-drop across the bus 110.

Solid-state fuse 100 may further include a controller 700. Bus measurement circuit 120 may be coupled to the controller 700 such that the bus measurement circuit 120 may provide the voltage across the bus 110 to the controller 700. Controller 700 may be configured to determine a current slope signal indicative of a current slope of the system current based at least in part on the voltage across the bus 110. In some embodiments, the current slope signal may be a voltage signal having a voltage level corresponding to the voltage-drop across the bus 110.

Controller 700 may be further configured to control the one or more solid-state switching devices 112, 114 to disconnect the first power terminal 102 from the second power terminal 104 based at least in part on the current slope signal. Switching devices 112, 114 may be configured in a bi-directional manner such that power terminal 102 may be disconnected from power terminal 104 and power terminal 104 is disconnected from power terminal 102. For instance, controller 700 may be coupled to each solid-state switching device 112, 114 such that the controller 700 may control the solid-state switching device 112, 114 to control the flow of current from the first terminal 102 to the second terminal 104 as well as the flow of current from the second terminal 104 to the first terminal 102. Solid-state fuse 100 may further include additional control circuitry 128 coupled between the controller 700 and each solid-state switching device 112, 114 for controlling each switching device 112, 114.

In some embodiments, solid-state fuse 100 may further include one or more temperature sensors 124, 126, such as negative temperature coefficient (NTC) thermistor(s), configured to determine a temperature measurement indicative of a temperature within the solid-state fuse 100. Controller 700 may be configured to control the one or more solid-state switching devices 112, 114 to disconnect the first power terminal 102 from the second power terminal 104 based at least in part on the current slope signal and the temperature measurement. For instance, controller 700 may compare the current slope signal and the temperature measurement to threshold values. Controller 700 may then control the solid-state switching devices to disconnect (e.g., open) based on the output of the comparisons.

Solid-state fuse 100 may further include a protection circuit 130 configured to provide additional short-circuit protection to the solid-state fuse 100. Protection circuit 130 is configured to protect solid-state switching devices 112, 114 (e.g., FETs) during switching. After the solid-state switching devices 112, 114 have switched to an off state (e.g., disconnected), the current may flow through protection circuit 130 due to, for instance, self-inductance in the cables, etc. When solid-state fuse 100 is conducting current (e.g., over bus 110), no current may be flowing over protection circuit 130. As shown in FIG. 1, protection circuit 130 may be positioned in parallel with the bus 110 and both switching devices 112, 114, such that protection circuit 130 is be coupled between the first power terminal 102 and the second power terminal 104.

As shown, solid-state fuse 100 may also include a housing 106 configured to house the components of the solid-state fuse 100. For instance, controller 700 may be an internal component positioned within housing 106 of solid-state fuse 100. In some embodiments, solid-state fuse 100 may include a high-voltage side (HV) and a low-voltage side (LV). The high-voltage side may be electrically and/or physically isolated from the low-voltage side (LV). For instance, solid-state fuse 100 may include one or more galvanic isolation components such as a transformer or an opto-isolator configured to isolate the high-voltage side (HV) from the low-voltage side (LV) of solid-state fuse 100. Solid-state fuse 100 may further include a communication interface 202 (e.g., I/O terminal) such that the fuse 100 can communicate over a network such as a controller area network (CAN). As shown, communication interface 202 may be positioned on the low-voltage side (LV) of solid-state fuse 100.

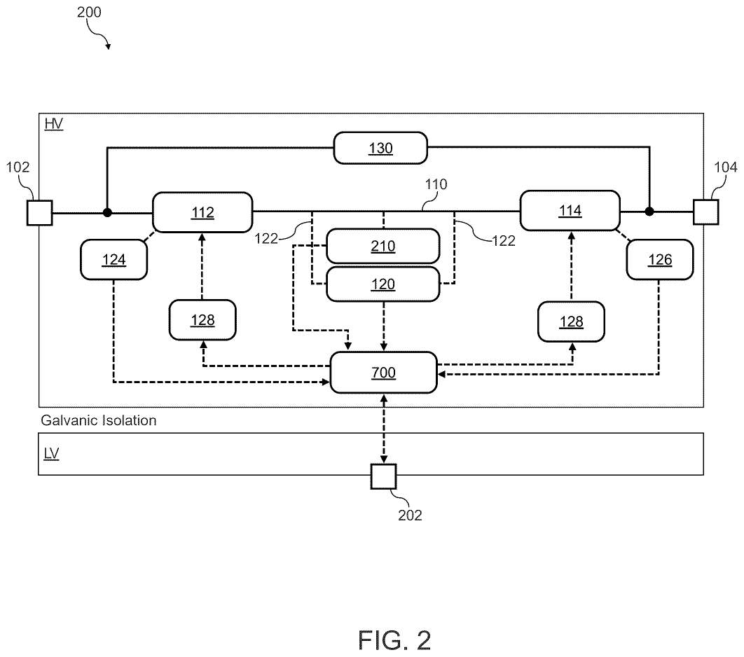

Referring now to FIG. 2, a schematic implementation of another solid-state fuse 200 according to example embodiments of the present disclosure is provided. Solid-state fuse 200 is a resettable solid-state fuse having a first power terminal 102 and a second power terminal 104. The solid-state fuse 200 may be implemented within a power system, such as a high-power system, to connect/disconnect one or more first components of the power system from one or more second components of the power system. For example, first power terminal 102 may be coupled to the one or more first components of a power system and second power terminal 104 may be coupled to one or more second components of a power system. Solid-state fuse 200 may be a bidirectional fuse configured to control the flow of electricity in both directions (e.g., from first power terminal 102 to second power terminal 104, from second power terminal 104 to first power terminal 102). As such, the solid-state fuse 200 may bidirectionally disconnect the first power terminal 102 from the second power terminal 104 such that electricity may not flow in either direction (e.g., from first power terminal 102 to second power terminal 104, from second power terminal 104 to first power terminal 102). Additionally and/or alternatively, solid-state fuse 100 may be configured to unidirectionally disconnect the first power terminal 102 from the second power terminal 104 such that electricity may not flow in a first direction (e.g., from the first power terminal 102 to the second power terminal 104) or unidirectionally disconnect the second power terminal 104 from the first power terminal 102 such that electricity may not flow in a second direction opposite the first direction (e.g., from the second power terminal 104 to the first power terminal 102). In some embodiments, the power system may be a power system of an electric vehicle.

Solid-state fuse 200 may include one or more solid-state switching devices 112, 114. While two solid-state switching devices 112, 114 are depicted in FIG. 2, those of ordinary skill in the art will understand that any suitable number of solid-state switching devices may be used without deviating from the scope of the present disclosure. Solid-state switching devices 112, 114 may each include one or more power semiconductor device, such as a SiC-FET, GaN-FET, Si-MOSFET, IGBT, etc. For instance, each solid-state switching device 112, 114 may include a singular power semiconductor device. In alternative embodiments, each solid state switching device 112, 114 may include a plurality of power semiconductor devices in a parallel configuration. By configuring the power semiconductor devices in parallel, the current capability of the solid-state fuse 200 may be increased. Solid-state switching devices 112, 114 may be configured in a bidirectional manner such that the solid-state switching devices 112, 114 may adjust the flow of electricity in both directions (e.g., from first power terminal 102 to second power terminal 104, from second power terminal 104 to first power terminal 102). For instance, solid-state fuse 200 may bidirectionally disconnect the first power terminal 102 from the second power terminal 104 using switching devices 112, 114 such that electricity may not flow from the first power terminal 102 to the second power terminal 104 or from the second power terminal 104 to the first power terminal 102.

As shown in FIG. 2, solid-state fuse 200 may further include a bus 110. Bus 110 may be coupled between a first solid-state switching device 112 and a second solid-state switching device 114. For instance, bus 110 may couple the first solid-state switching device 112 to the second solid-state switching device 114. While bus 110 is illustrated in FIG. 2 as being coupled between a first solid-state switching device 112 and a second solid-state switching device 114, those of ordinary skill in the art will understand that this is done for purposes of illustration and discussion and that bus 110 may be located at other suitable positions within the solid-state fuse 200. When the first power terminal 102 and the second power terminal 104 are connected, bus 110 may be operable to conduct at least a portion of the system current. Bus 110 may be any suitable type of bus (e.g., busbar) with a known inductance. As current is flowing over the bus 110, a voltage drop may be generated. In some embodiments, the resistance of the bus 110 may be in a range of about 0.1 microohms to about 200 microohms, such as in a range of about 0.1 microohms to about 50 microohms, such as about 10 microohms. Additionally and/or alternatively, the inductance of bus 110 may be in a range of about 0.1 nanohenrys (nH) to about 50 nanohenrys, such as about 10 nanohenrys. In some embodiments, solid-state fuse 200 may include a printed circuit board (PCB) bus system, such as a PCB bus system disclosed below. For instance, bus 110 may be a busbar, such as a copper busbar (e.g., Cu-busbar) coupled to a printed circuit board (PCB.

Solid-state fuse 200 may further include a bus measurement circuit 120 configured to measure a voltage across the bus 110. As shown, bus measurement circuit 120 may be coupled to the bus 110. In some embodiments, bus measurement circuit 120 may include a pair of bond wires coupled to the bus 110 via voltage tabs 122. Each voltage tab 122 may be positioned on an end of the bus 110 such that a voltage-drop across the bus 110 may be measured. Bus measurement circuit 120 may further include an amplifier circuit configured to determine the voltage-drop across the bus 110.

Solid-state fuse 200 may further include a controller 700. Bus measurement circuit 120 may be coupled to the controller 700 such that the bus measurement circuit 120 may provide the voltage across the bus 110 to the controller 700. Controller 700 may be configured to determine a current slope signal indicative of a current slope of the system current based at least in part on the voltage across the bus 110. In some embodiments, the current slope signal may be a voltage signal having a voltage level corresponding to the voltage-drop across the bus 110.

Controller 700 may be further configured to control the one or more solid-state switching devices 112, 114 to disconnect the first power terminal 102 from the second power terminal 104 based at least in part on the current slope signal. Switching devices 112, 114 may be configured in a bi-directional manner such that power terminal 102 may be disconnected from power terminal 104 and power terminal 104 is disconnected from power terminal 102. For instance, controller 700 may be coupled to each solid-state switching device 112, 114 such that the controller 700 may control the solid-state switching device 112, 114 to control the flow of current from the first terminal 102 to the second terminal 104 as well as the flow of current from the second terminal 104 to the first terminal 102. Solid-state fuse 100 may further include additional control circuitry 128 coupled between the controller 700 and each solid-state switching device 112, 114 for controlling each switching device 112, 114.

In some embodiments, solid-state fuse 200 may further include one or more temperature sensors 124, 126, such as negative temperature coefficient (NTC) thermistor(s), configured to determine a temperature measurement indicative of a temperature within the solid-state fuse 200. Controller 700 may be configured to control the one or more solid-state switching devices 112, 114 to disconnect the first power terminal 102 from the second power terminal 104 based at least in part on the current slope signal and the temperature measurement. For instance, controller 700 may compare the current slope signal and the temperature measurement to threshold values. Controller 700 may then control the solid-state switching devices to disconnect (e.g., open) based on the output of the comparisons.

In some embodiments, solid-state fuse 200 may further include a protection circuit 130 configured to provide additional short-circuit protection to the solid-state fuse 200. Protection circuit 130 is configured to protect solid-state switching devices 112, 114 (e.g., FETs) during switching. After the solid-state switching devices 112, 114 have switched to an off state, the current may flow through protection circuit 130 due to, for instance, self-inductance in the cables, etc. When solid-state fuse 100 is conducting current (e.g., over bus 110), no current may be flowing over protection circuit 130. As shown in FIG. 2, protection circuit 130 may be positioned in parallel with the bus 110 and both switching devices 112, 114, such that protection circuit 130 is be coupled between the first power terminal 102 and the second power terminal 104.

Solid-state fuse 200 may further include a current sensor 210 coupled to the bus 110. Current sensor 210 may be configured to determine a current measurement indicative of a bus current provided on the bus 110. Current sensor 210 may be independent from the bus measurement circuit 120. For instance, current sensor 210 may measure the electric or magnetic field due to the current and thereby may be independent of voltage-drops due to, for example, inductances. Current sensor 210 may be a tunnel magneto resistance (TMR) sensor, a hall-based sensor, or any other suitable type of current sensor.

Controller 700 may be configured to control the one or more solid-state switching devices 112, 114 to disconnect the first power terminal 102 from the second power terminal 104 based at least in part on the current slope signal and the current measurement provided by current sensor 210. For instance, controller 700 may compare the current slope signal and the current measurement to threshold values. Controller 700 may then control the solid-state switching devices to disconnect (e.g., open) based on the output of the comparisons.

As shown in FIG. 2, solid-state fuse 200 may include a high-voltage side (HV) and a low-voltage side (LV). The high-voltage side may be electrically and/or physically isolated from the low-voltage side (LV). For instance, solid-state fuse 200 may include one or more galvanic isolation components such as a transformer or an opto-isolator configured to isolate the high-voltage side (HV) from the low-voltage side (LV) of solid-state fuse 200.

Solid-state fuse 200 may further include a communication interface 202 (e.g., I/O terminal) such that the fuse 200 can communicate over a network such as a controller area network (CAN). As shown, communication interface 202 may be positioned on the low-voltage side (LV) of solid-state fuse 200.

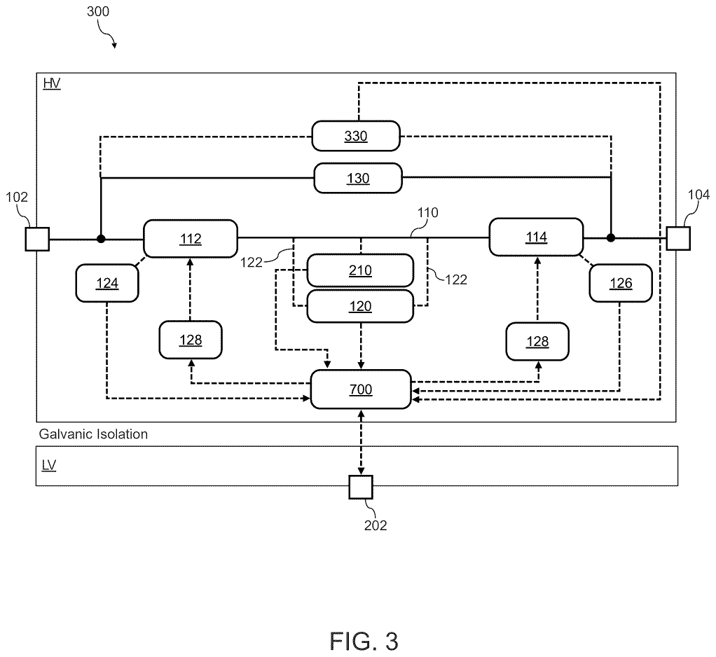

FIG. 3 provides a schematic implementation of another solid-state fuse 300 according to example embodiments of the present disclosure. Solid-state fuse 300 is a resettable solid-state fuse having a first power terminal 102 and a second power terminal 104. The solid-state fuse 300 may be implemented within a power system, such as a high-power system, to connect/disconnect one or more first components of the power system from one or more second components of the power system. For example, first power terminal 102 may be coupled to the one or more first components of a power system and second power terminal 104 may be coupled to one or more second components of a power system. Solid-state fuse 300 may be a bidirectional fuse configured to control the flow of electricity in both directions (e.g., from first power terminal 102 to second power terminal 104, from second power terminal 104 to first power terminal 102). As such, the solid-state fuse 300 may bidirectionally disconnect the first power terminal 102 from the second power terminal 104 such that electricity may not flow in either direction (e.g., from first power terminal 102 to second power terminal 104, from second power terminal 104 to first power terminal 102). Additionally and/or alternatively, solid-state fuse 100 may be configured to unidirectionally disconnect the first power terminal 102 from the second power terminal 104 such that electricity may not flow in a first direction (e.g., from the first power terminal 102 to the second power terminal 104) or unidirectionally disconnect the second power terminal 104 from the first power terminal 102 such that electricity may not flow in a second direction opposite the first direction (e.g., from the second power terminal 104 to the first power terminal 102). In some embodiments, the power system may be a power system of an electric vehicle.

Solid-state fuse 300 may include one or more solid-state switching devices 112, 114. While two solid-state switching devices 112, 114 are depicted in FIG. 3, those of ordinary skill in the art will understand that any suitable number of solid-state switching devices may be used without deviating from the scope of the present disclosure. Solid-state switching devices 112, 114 may each include one or more power semiconductor device, such as a SiC-FET, GaN-FET, Si-MOSFET, IGBT, etc. For instance, each solid-state switching device 112, 114 may include a singular power semiconductor device. In alternative embodiments, each solid state switching device 112, 114 may include a plurality of power semiconductor devices in a parallel configuration. By configuring the power semiconductor devices in parallel, the current capability of the solid-state fuse 100 may be increased. Solid-state switching devices 112, 114 may be configured in a bidirectional manner such that the solid-state switching devices 112, 114 may adjust the flow of electricity in both directions (e.g., from first power terminal 102 to second power terminal 104, from second power terminal 104 to first power terminal 102). For instance, solid-state fuse 300 may bidirectionally disconnect the first power terminal 102 from the second power terminal 104 using switching devices 112, 114 such that electricity may not flow from the first power terminal 102 to the second power terminal 104 or from the second power terminal 104 to the first power terminal 102.

As shown in FIG. 3, solid-state fuse 300 may further include a bus 110. Bus 110 may be coupled between a first solid-state switching device 112 and a second solid-state switching device 114. For instance, bus 110 may couple the first solid-state switching device 112 to the second solid-state switching device 114. While bus 110 is illustrated in FIG. 3 as being coupled between a first solid-state switching device 112 and a second solid-state switching device 114, those of ordinary skill in the art will understand that this is done for purposes of illustration and discussion and that bus 110 may be located at other suitable positions within the solid-state fuse 300. When the first power terminal 102 and the second power terminal 104 are connected, bus 110 may be operable to conduct at least a portion of the system current. Bus 110 may be any suitable type of bus (e.g., busbar) with a known inductance. As current is flowing over the bus 110, a voltage drop may be generated. In some embodiments, the resistance of the bus 110 may be in a range of about 0.1 microohms to about 200 microohms, such as in a range of about 0.1 microohms to about 50 microohms, such as about 10 microohms. Additionally and/or alternatively, the inductance of bus 110 may be in a range of about 0.1 nanohenrys (nH) to about 50 nanohenrys, such as about 10 nanohenrys. In some embodiments, solid-state fuse 300 may include a printed circuit board (PCB) bus system, such as a PCB bus system disclosed below. For instance, bus 110 may be a busbar, such as a copper busbar (e.g., Cu-busbar) coupled to a printed circuit board (PCB).

Solid-state fuse 300 may further include a bus measurement circuit 120 configured to measure a voltage across the bus 110. As shown, bus measurement circuit 120 may be coupled to the bus 110. In some embodiments, bus measurement circuit 120 may include a pair of bond wires coupled to the bus 110 via voltage tabs 122. Each voltage tab 122 may be positioned on an end of the bus 110 such that a voltage-drop across the bus 110 may be measured. Bus measurement circuit 120 may further include an amplifier circuit configured to determine the voltage-drop across the bus 110.

Solid-state fuse 300 may further include a controller 700. Bus measurement circuit 120 may be coupled to the controller 700 such that the bus measurement circuit 120 may provide the voltage across the bus 110 to the controller 700. Controller 700 may be configured to determine a current slope signal indicative of a current slope of the system current based at least in part on the voltage across the bus 110. In some embodiments, the current slope signal may be a voltage signal having a voltage level corresponding to the voltage-drop across the bus 110.

Controller 700 may be further configured to control the one or more solid-state switching devices 112, 114 to disconnect the first power terminal 102 from the second power terminal 104 based at least in part on the current slope signal. Switching devices 112, 114 may be configured in a bi-directional manner such that power terminal 102 may be disconnected from power terminal 104 and power terminal 104 is disconnected from power terminal 102. For instance, controller 700 may be coupled to each solid-state switching device 112, 114 such that the controller 700 may control the solid-state switching device 112, 114 to control the flow of current from the first terminal 102 to the second terminal 104 as well as the flow of current from the second terminal 104 to the first terminal 102. Solid-state fuse 100 may further include additional control circuitry 128 coupled between the controller 700 and each solid-state switching device 112, 114 for controlling each switching device 112, 114.

In some embodiments, solid-state fuse 300 may further include one or more temperature sensors 124, 126, such as negative temperature coefficient (NTC) thermistor(s), configured to determine a temperature measurement indicative of a temperature within the solid-state fuse 300. Controller 700 may be configured to control the one or more solid-state switching devices 112, 114 to disconnect the first power terminal 102 from the second power terminal 104 based at least in part on the current slope signal and the temperature measurement. For instance, controller 700 may compare the current slope signal and the temperature measurement to threshold values. Controller 700 may then control the solid-state switching devices to disconnect (e.g., open) based on the output of the comparisons.

Solid-state fuse 300 may further include a current sensor 210 coupled to the bus 110. Current sensor 210 may be configured to determine a current measurement indicative of a bus current provided on the bus 110. Current sensor 210 may be independent from the bus measurement circuit 120. For instance, current sensor 210 may measure the electric or magnetic field due to the current and thereby may be independent of voltage-drops due to, for example, inductances. Current sensor 210 may be a tunnel magneto resistance (TMR) sensor, a hall-based sensor, or any other suitable type of current sensor.

Controller 700 may be configured to control the one or more solid-state switching devices 112, 114 to disconnect the first power terminal 102 from the second power terminal 104 based at least in part on the current slope signal and the current measurement provided by current sensor 210. For instance, controller 700 may compare the current slope signal and the current measurement to threshold values. Controller 700 may then control the solid-state switching devices to disconnect (e.g., open) based on the output of the comparisons.

As shown in FIG. 3, solid-state fuse 300 may include a high-voltage side (HV) and a low-voltage side (LV). The high-voltage side may be electrically and/or physically isolated from the low-voltage side (LV). For instance, solid-state fuse 300 may include one or more galvanic isolation components such as a transformer or an opto-isolator configured to isolate the high-voltage side (HV) from the low-voltage side (LV) of solid-state fuse 300.

Solid-state fuse 300 may further include a communication interface 202 (e.g., I/O terminal) such that the fuse 300 can communicate over a network such as a controller area network (CAN). As shown, communication interface 202 may be positioned on the low-voltage side (LV) of solid-state fuse 300.

In some embodiments, solid-state fuse 300 may further include a protection circuit 130 configured to provide additional short-circuit protection to the solid-state fuse 300. Protection circuit 130 is configured to protect solid-state switching devices 112, 114 (e.g., FETs) during switching. After the solid-state switching devices 112, 114 have switched to an off state, the current may flow through protection circuit 130 due to, for instance, self-inductance in the cables, etc. When solid-state fuse 100 is conducting current (e.g., over bus 110), no current may be flowing over protection circuit 130. As shown in FIG. 3, protection circuit 130 may be positioned in parallel with the bus 110 and both switching devices 112, 114, such that protection circuit 130 is be coupled between the first power terminal 102 and the second power terminal 104.

Solid-state fuse 300 may further include a desaturation detection circuit 330 (e.g., desaturation protection circuit). Desaturation detection circuit 330 may be configured to detect a short circuit event. For instance, desaturation detection circuit 330 may be configured to measure the voltage drop across the switching devices 112, 114 (e.g., FETs) during an on state (e.g., while conducting current over bus 110) of the switching devices 112, 114. The desaturation detection circuit 330 may provide a protection signal indicating the voltage drop across the switching devices 112, 114 to controller 700. For instance, the protection signal may be a voltage signal with a voltage level corresponding to the voltage drop across the switching devices 112, 114. As shown in the equation below, the voltage level of the protection signal (V_{desat}) may correspond to the current over the switching devices 112, 114 (I_{SD}). Specifically, the voltage level of the protection signal (V_{desat}) may increase as the current over the switching devices 112, 114 (I_{SD}) increases.

$${V}_{desat} = {R}_{S D} * {I}_{S D}$$

Controller 700 may control the one or more solid state switching devices 112, 114 based at least in part on the protection signal indicating the voltage drop across the switching devices 112, 114. For instance, if the voltage drop across the switching devices 112, 114 reaches a threshold value (e.g., voltage threshold) indicating a short circuit event, controller 700 may be configured to disconnect power terminal 102 from power terminal 104.

In some embodiments, the desaturation detection circuit 330 (e.g., desaturation protection circuit) may be coupled to controller 700. The desaturation detection circuit 330 may provide a protection signal to controller 700. Controller 700 may be configured to control the one or more solid-state switching devices 112, 114 to disconnect one or more first components of a power system from one or more second components of the power system based at least in part on the current slope signal and the protection signal.

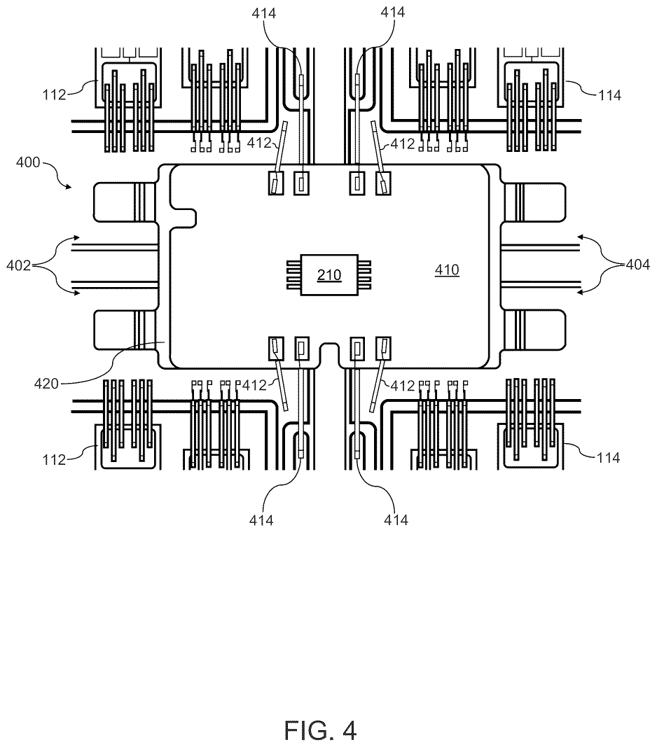

FIG. 4 illustrates a top-down view of an example printed circuit board (PCB) bus system 400 according to example embodiments of the present disclosure. PCB bus system 400 may be implemented within a solid-state fuse according to example embodiments of the present disclosure, such as, for instance, solid-state fuse 100 of FIG. 1, solid-state fuse 200 of FIG. 2, or solid-state fuse 300 of FIG. 3.

PCB bus system 400 may include a busbar 420 (e.g., bus), such as a copper busbar, and a printed circuit board (PCB) 410. In some embodiments, the PCB 410 may be coupled (e.g., soldered, glued, etc.) to the busbar 420. As shown, busbar 420 may be coupled between a first solid-state switching devices 112 and a second solid-state switching device 114. As previously described, each solid state switching device 112, 114 may include a plurality of power semiconductor devices. As shown in FIG. 4, first solid-state switching devices 112 may include two power switching devices and first solid-state switching devices 114 may also include two power switching devices.

As shown in FIG. 4, PCB bus system 400 is electrically coupled to (by soldering, welding, etc.) a first substrate 402 on a first end and to a second substrate 404 on a second end. While the first substrate 402 and second substrate 404 are illustrated in FIG. 4 as separate substrates, those of ordinary skill in the art will understand that this is done for purposes of illustration and discussion to show that the first substrate 402 and the second substrate 404 are electrically isolated such that current between the substrates 402, 404 may only flow through the busbar 420 of PCB bus system 400.

PCB 410 may include one or more components configured to measure a voltage across the busbar 420. For instance, wire bond(s) 412 may be coupled to each side of the busbar 420 via PCB 410. Additionally, one or more wire bonds 414 may be coupled to a controller, such as controller 700 depicted in FIGS. 1-3, such that a signal indicative of the voltage across the busbar 420 may be provided to the controller.

In some embodiments, a current sensor 210 may be positioned (e.g., mounted) on the PCB 410 of the PCB bus system 400. Current sensor 210 may be configured to determine a current measurement indicative of a bus current provided on the busbar 420. For instance, current sensor 210 may be coupled to the busbar 420 via PCB 410 and/or one or more wire bonds. Current sensor 210 may be a tunnel magneto resistance (TMR) sensor, a hall-based sensor, or any other suitable type of current sensor. Current sensor 210 may also be coupled to a controller, such as controller 700 depicted in FIGS. 1-3 via, for instance, one or more wire bonds 414. As such, current sensor 210 may be configured to provide a signal indicative of the current measurement to the controller via the one or more wire bonds 414.

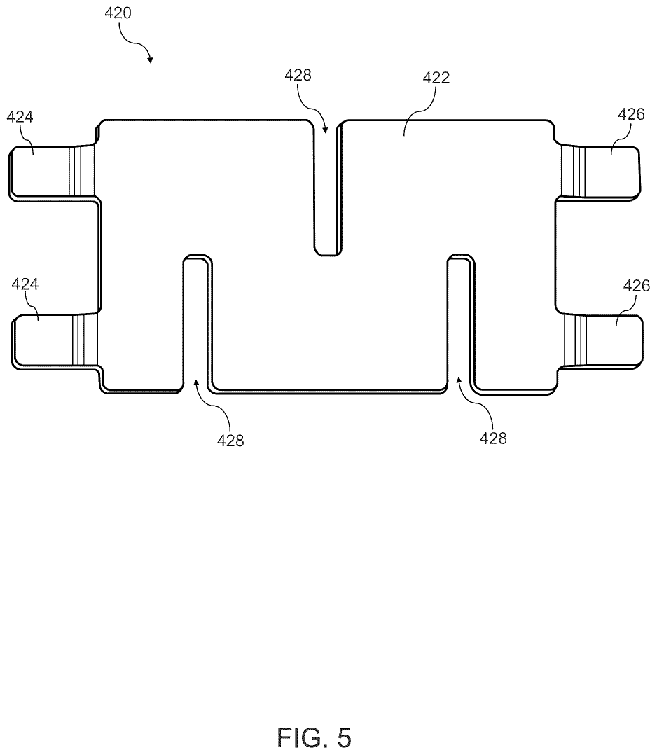

FIG. 5 illustrates a top-down view of an example busbar 420 of the PCB bus system 400 provided in FIG. 4. In some embodiments, busbar 420 may be a copper busbar (e.g., Cu-busbar) or other suitable electrical conductor.

As shown, busbar 420 may include a generally rectangular body portion 422 and a plurality of coupling portions 424, 426 (e.g., terminals). Coupling portions 424, 426 may be configured to couple the busbar 420 to, for instance, a substrate. For instance, first coupling portions 424 positioned on a first side of the busbar 420 may be coupled to a first substrate 402 (FIG. 4), while second coupling portions 426 positioned on a second (e.g., opposite) side of the busbar 420 may be coupled to a second substrate 404 (FIG. 4). In some embodiments, the body portion 422 of the busbar 420 may include one or more notches 428, such as three notches 428.

Busbar 420 may have one or more electrical characteristics. For example, a resistance of busbar 420 may be in a range of about 0.1 microohms (μΩ) to about 200 microohms, such as in a range of about 0.1 microohms to about 50 microohms, such as about 10 microohms. Additionally and/or alternatively, the inductance of busbar 420 may be in a range of about 0.1 nanohenrys (nH) to about 50 nanohenrys, such as about 10 nanohenrys.

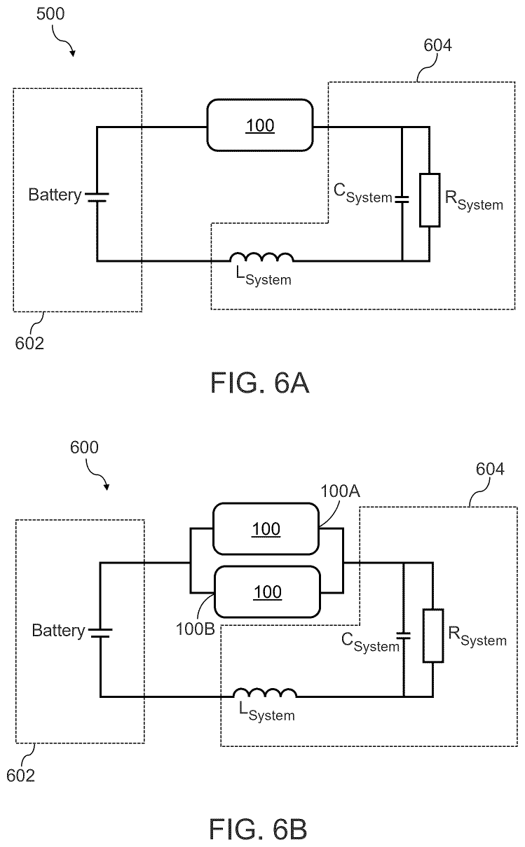

FIGS. 6A and 6B provide circuit schematics of example power systems 500, 600 according to example embodiments of the present disclosure. While power systems 500, 600 are generally described with reference to solid-state fuse 100 depicted in FIG. 1, those of ordinary skill in the art will understand that power systems 500, 600 may include any suitable solid-state fuse provided herein, such as solid-state fuse 200 depicted in FIG. 2 or solid-state fuse 300 depicted in FIG. 3, without deviating from the scope of the present disclosure.

As shown in FIGS. 6A and 6B, the one or more first components 602 may include, for instance, a direct current (DC) source such as a battery operable to provide power to the system. For purposes of illustration, the one or more second components 604 are represented in FIGS. 6A and 6B by capacitive, resistive and inductive system elements (e.g., C_{system}, R_{sysytem}, L_{sysytem}) operable to receive power from the one or more first components 602 (e.g., battery). Those of ordinary skill in the art will understand that the configuration of the capacitive, resistive and inductive system elements (e.g., C_{system}, R_{sysytem}, L_{sysytem}) depicted in FIGS. 6A and 6B are for purposes of illustration and discussion. Accordingly, power systems 500, 600 may include any suitable type and/or number of second components 604 having any suitable configuration of capacitive, resistive, and/or inductive system elements without deviating from the scope of the present disclosure. Power systems 500, 600 may be high-power systems, such as, for instance, a power conversion system, a power storage system, an electric drive control system, etc.

In some embodiments, power systems 500, 600 may be power systems of an electric vehicle. For instance, the one or more second components 604 may include a direct current (DC) link capacitor and/or inverter, such as a traction inverter operable to provide power to a motor of the electric vehicle.

Referring now specifically to FIG. 6A, example power system 500 according to example embodiments of the present disclosure is provided. Power system 500 includes a solid-state fuse 100 coupled in series between the one or more first components 602 and the one or more second components 604.

Solid-state fuse 100 may be configured to disconnect the one or more first components 602 from the one or more second components 604. For instance, solid-state fuse 100 may determine a current slope of a system current flowing through the power system 500 based at least in part on a voltage across an internal bus of solid-state fuse 100, such as bus 110 depicted in FIG. 1. The solid-state fuse may disconnect the one or more first components 602 from the one or more second components 604 based at least in part on the current slope.

Referring now specifically to FIG. 6B, example power system 600 according to example embodiments of the present disclosure is provided. Power system 600 includes a plurality of solid-state fuses 100 (e.g., independent solid-state fuses 100) coupled in parallel between the one or more first components 602 and the one or more second components 604.

While power system 600 is depicted in FIG. 6B as having two solid-state fuses 100 (e.g., fuse 100A and fuse 100B) configured in parallel, those of ordinary skill in the art will understand that power system 600 may include any number of solid-state fuses 100 coupled in parallel without deviating from the scope of the present disclosure. In some embodiments, the number of solid-state fuses 100 may be determined based on the system current of the power system 600. For instance, power system 600 may have a system current that is far greater than the current rating of a single solid-state fuse 100. As such, the number of solid-state fuses 100 coupled in parallel may be determined such that the plurality of solid-state fuses 100 in parallel may handle the system current.

The plurality of solid-state fuses 100 may be configured to disconnect the one or more first components 602 from the one or more second components 604. For instance, when a first fuse 100A disconnects (e.g., switches to an open state), a second fuse 100B may determine an increase in the current slope due to the disconnection of the first fuse 100A and disconnect (e.g., switch to an open state). Accordingly, if any solid-state fuse 100 disconnects (e.g., switches to an open state), the other solid-state fuses 100 coupled in parallel may also disconnect.

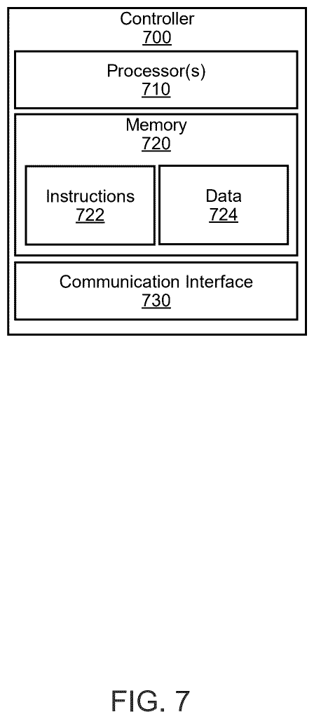

FIG. 7 provides a block diagram of a controller 700 according to example embodiments of the present disclosure.

As shown, controller 700 may include one or more processors 702 configured to perform a variety of computer-implemented functions (e.g., performing the methods, steps, calculations and the like disclosed herein). As used herein, the term “processor” refers not only to integrated circuits referred to in the art as being included in a computer, but also refers to any suitable processing device(s), such as a controller, microcontroller, a microcomputer, a programmable logic controller (PLC), an application specific integrated circuit (ASIC), a Field Programmable Gate Array (FPGA), and/or other programmable circuits.

Controller 700 may further include, or be associated with, one or more memory devices 704. Examples of the memory devices 704 can include computer-readable media including, but not limited to, non-transitory computer-readable media, such as RAM, ROM, hard drives, flash drives, or other suitable memory devices. The one or more memory devices 704 can store information or data accessible by the one or more processors 702. Memory devices 704 may be separate components from the processor(s) 702 or may be included onboard within the processor(s) 702. In some embodiments, memory devices 704 may be configured to store instructions 706 that may be executed by the processor(s) 702. Memory devices 704 may also store data 708 accessible to the one or more processors 702.

In some embodiments, controller 700 may further include communication circuitry 710 to communicate over a network, such as a controller area network (CAN). For instance, communication circuitry 710 may include a communication interface, such as communication interface 202 (e.g., I/O terminal) shown in FIGS. 2 and 3.

In some embodiments, controller 700 may further include a machine-learned model that may be, for instance, saved within the one or more memory devices 704. The machine-learned model may be trained with correct and false trigger inputs. For instance, training data may include input data such as a current slope signal. The input data may be labeled as correct or false based on if the input data corresponds to an overcurrent event, such as a short circuit event.

In operation, a current slope signal and/or other input data may be provided to the machine learned model. The machine learned model may then provide an output based on the current slope signal and/or other input data, and the controller 700 may disconnect (e.g., trigger an interruption) based at least in part on the output of the machine learned model. As such, the machine-learned model may be configured to optimize the interruption trigger time and/or the false trigger percentage.

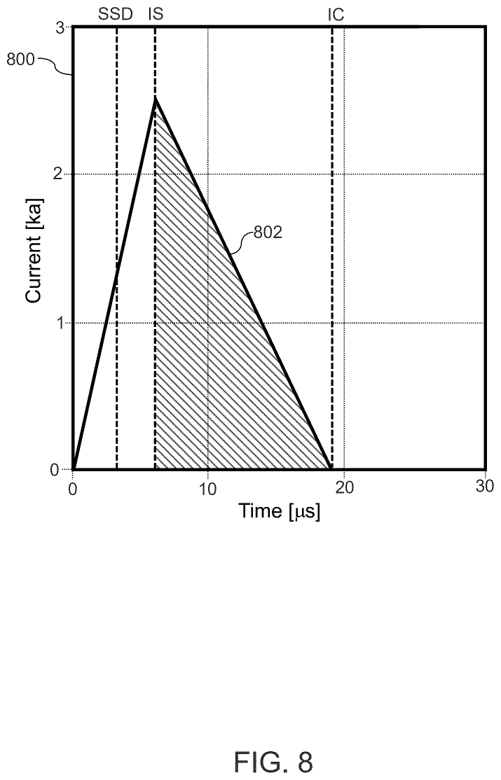

FIG. 8 provides a plot 800 depicting an example interruption provided by a solid-state fuse according to example embodiments of the present disclosure during an example over current event. While the example signal depicted in plot 800 is generally described below with reference to solid-state fuse 100 of FIG. 1, those of ordinary skill in the art will understand that the example signal depicted in plot 800 may be provided by other solid-state fuses provided herein, such as by solid-state fuse 200 of FIG. 2 or solid-state fuse 300 of FIG. 3.

Specifically, plot 800 shown in FIG. 8 depicts a current 802 flowing through a solid-state fuse 100 over a period of time. Based at least in part on the slope of current 802, solid-state fuse 100 may initiate an interruption to disconnect (e.g., bidirectionally disconnect) one or more first components of a power system from one or more second components of the power system. For instance, the slope of current 802 may indicate that a short circuit event is occurring. As shown, fuse 100 may detect that a short circuit event is occurring at a short circuit detected time (SSD). After detecting that a short circuit event is occurring, fuse 100 may initiate an interruption at an interruption started (IS) time and complete the interruption at an interruption completed (IC) time.

The direct trigger implemented by internal circuitry of the solid-state fuse 100 (e.g., controller 700, solid-state switching devices 112, 114, etc.) may provide for fast interruption during a short circuit event. For instance, the triggering time (e.g., time period from short circuit detection (SSD) time to interruption started (IS) time) of solid-state fuse 100 may be less than about 20 microseconds, such as less than about 10 microseconds, such as less than about 5 microseconds. In addition, the interruption time (e.g., time period from IS time to IC time) of solid-state fuse 100 may be less than about 100 microseconds, such as less than about 25 microseconds, such as less than about 15 microseconds.

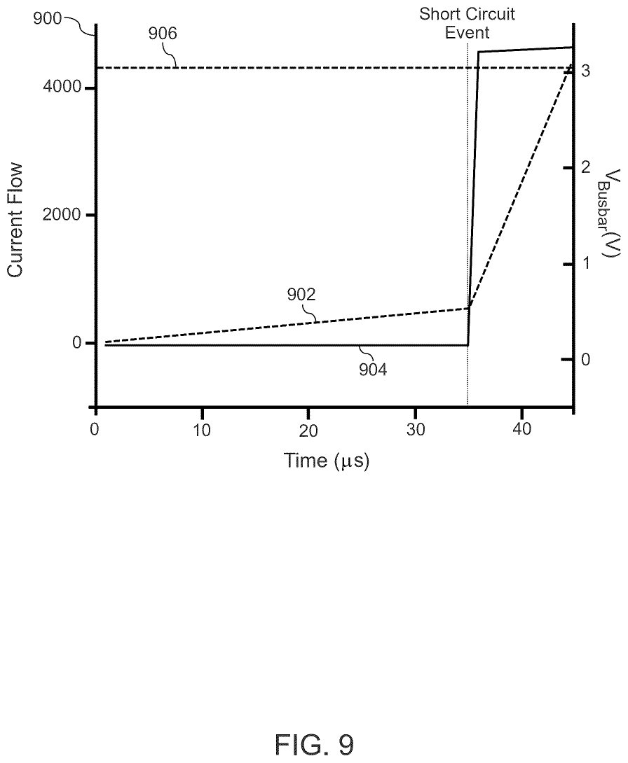

FIG. 9 provides a plot 900 depicting example signals of a solid-state fuse according to example embodiments of the present disclosure during a short circuit event. While the example signals depicted in plot 900 are generally described with reference to solid-state fuse 100 of FIG. 1, those of ordinary skill in the art will understand that the example signals depicted in plot 900 may be provided by other solid-state fuses provided herein, such as by solid-state fuse 200 of FIG. 2 or solid-state fuse 300 of FIG. 3.

Specifically, plot 900 provides an example system current 902 and an example current slope signal 904 indicative of a current slope of the system current 902. As shown, current slope signal 904 may be a voltage signal determined based at least in part on a voltage across bus 110 (FIGS. 1-3). As previously described, one or more electrical characteristics of the bus 110 (e.g., inductance, resistance) may be configured such that the voltage across the bus 110 (e.g., V_{Bus}) is indicative of a current slope (di/dt) of the system current 902. As such, a voltage level of current slope signal 904 may correspond to a voltage measured across the bus 110 (e.g., V_{Bus}) that indicates a current slope (di/dt) of the system current 902. As shown in plot 900, the voltage level of current slope signal 904 may indicate a current slope (di/dt) of system current 902.

When a short circuit event is initiated, the system current 902 may begin to increase at a fast rate. As shown, the voltage level of the current slope signal 904 may indicate a current slope (di/dt) of the system current 902 during a short circuit event. As such, triggering an interruption based on the current slope (di/dt) determined by the current slope signal 904 may provide for disconnection before the system current 902 reaches levels that may damage components of the system and/or solid-state fuse.

For instance, current slope signal 904 may be compared to a threshold voltage value 906 by, for instance, an internal comparator of a controller, such as controller 700 (FIGS. 1-3). The threshold voltage value 906 may indicate a current slope (di/dt) of the system current 902 associated with a short circuit event. An interruption may be triggered when the current slope signal 904 is greater than the threshold voltage value 906, providing for a quick disconnection during a short circuit event.

In some embodiments, an interruption may be triggered and the controller, such as controller 700 (FIGS. 1-3), may control one or more solid-state switching devices to disconnect one or more first components of a power system from one or more second components of a power system based at least in part on the output signal of the comparator over a time period. For instance, as shown in FIG. 9, the comparator may output a high signal, indicating a short circuit event is occurring, when the current slope signal 904 is greater than threshold voltage value 906. The controller, such as controller 700 (FIGS. 1-3), may be configured to trigger the interruption when the comparator signal has remained high for a time period, such as, for instance, for about 10 microseconds. As such, the interruption may be triggered when the current slope signal 904 has been greater than the threshold voltage value 906 for a time period.

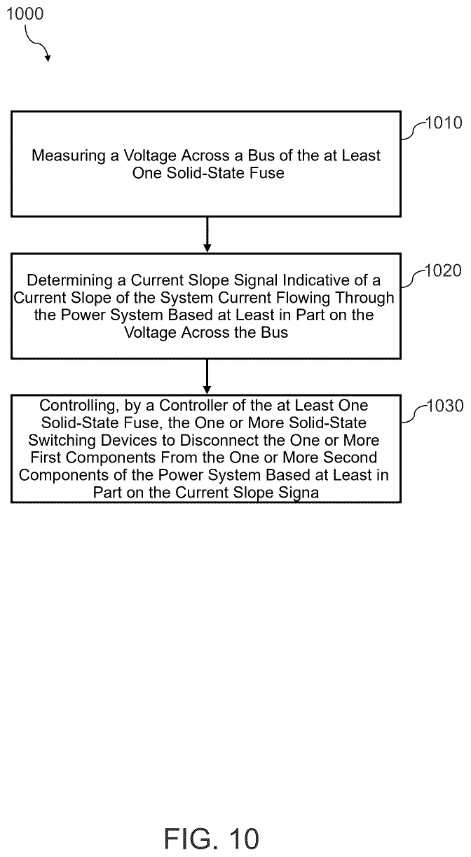

FIG. 10 provides an example method 1000 for controlling one or more solid-state switching devices of at least one solid-state fuse to disconnect one or more first components of a power system from one or more second components of the power system. While method 1000 is generally described with reference to solid-state fuse 100 of FIG. 1, those of ordinary skill in the art will understand that method 1000 may be used to control any of the solid-state fuses described herein, including the solid-state fuses described in FIGS. 1-3.

FIG. 10 depicts steps performed in a particular order for purposes of illustration and discussion. Those of ordinary skill in the art, using the disclosures provided herein, will understand that various steps of any of the methods described herein can be modified, rearranged, omitted, include steps not illustrated, and/or expanded in various ways without deviating from the scope of the present disclosure.

At 1010, method 1000 includes measuring a voltage across a bus of the at least one solid-state fuse. For instance, bus measurement circuit 120 may measure a voltage across a bus 110 of solid-state fuse 100.

At 1020, method 1000 includes determining a current slope signal indicating a current slope of a system current flowing through the power system based at least in part on the voltage across the bus. For instance, bus 110 may have one or more electrical characteristics (e.g., inductance, resistance) such that the voltage across the bus 110 (e.g., V_{Bus}) is indicative of a current slope (di/dt) of the system current. As such, controller 700 may determine a current slope signal indicative of a current slope of a system current based at least in part on the voltage across the bus 110 measured by measurement circuit 120.

At 1030, method 1000 includes controlling, by a controller of the at least one solid-state fuse, the one or more solid-state switching devices to bidirectionally disconnect the one or more first components from the one or more second components of the power system based at least in part on the current slope. For instance, controller 700 may control solid-state switching devices 112, 114 to bidirectionally disconnect the one or more first components 602 from the one or more second components 604 based at least in part on the current slope.

In some embodiments, controlling the one or more solid-state switching devices 112, 114 to disconnect the one or more first components 602 from the one or more second components 604 includes comparing, by a comparator, the current slope signal to a threshold value; and controlling, by the controller 700, the one or more solid-state switching devices 112, 114 to disconnect the one or more first components 602 from the one or more second components 604 based at least in part on an output signal of the comparator. For example, controller 700 may include an internal comparator. The comparator may compare the current slope signal to a threshold value to determine an output signal. When the current slope signal is less than the threshold value, the output signal may be low, indicating that a short circuit event is not taking place. When the current slope signal is greater than the threshold value, the output signal may be high, indicating that a short circuit event is taking place.

In some embodiments, the controller is configured to control the one or more solid-state switching devices to disconnect the one or more first components from the one or more second components based at least in part on the output signal of the comparator over a time period. For instance, controller 700 may be configured to disconnect the first power terminal 102 from the second power terminal 104 when the output signal of the comparator remains greater than a threshold value over a time period.

In some embodiments, determining a current slope signal indicative of a system current flowing through the power system is based at least in part on one or more electrical characteristics of the bus. For instance, the bus 110 may have a defined inductance and/or resistance such that the voltage across the bus 110 may indicate the current slope (di/dt) of the system current.

One example aspect of the present disclosure is directed to a method for controlling one or more solid-state switching devices of at least one solid-state fuse to disconnect one or more first components of a power system from one or more second components of the power system. The method includes measuring a voltage across a bus of the at least one solid-state fuse. The method further includes determining a current slope signal indicative of a current slope of a system current flowing through the power system based at least in part on the voltage across the bus. The method further includes controlling, by a controller of the at least one solid-state fuse, the one or more solid-state switching devices to bidirectionally or unidirectionally disconnect the one or more first components from the one or more second components of the power system based at least in part on the current slope signal.

In some examples, controlling the one or more solid-state switching devices to disconnect the one or more first components from the one or more second components comprises comparing, by a comparator, the current slope signal to a threshold value; and controlling, by the controller, the one or more solid-state switching devices to disconnect the one or more first components from the one or more second components based at least in part on an output signal of the comparator.

In some examples, the controller is configured to control the one or more solid-state switching devices to disconnect the one or more first components from the one or more second components based at least in part on the output signal of the comparator over a time period.

In some examples, an inductance of the bus is in a range of about 0.1 nanohenrys to about 50 nanohenrys.

In some examples, a resistance of the bus is in a range of about 0.1 microohms to about 200 microohms.

In some examples, the method further includes determining, by a current sensor, a current measurement indicative of a bus current provided on the bus. The controller is configured to control the one or more solid-state switching devices to disconnect the one or more first components from the one or more second components based at least in part on the current slope signal and the current measurement.

In some examples, the method further includes determining, by a temperature sensor, a temperature measurement indicative of a temperature within the at least one solid-state fuse. The controller is configured to control the one or more solid-state switching devices to disconnect the one or more first components from the one or more second components based at least in part on the current slope signal and the temperature measurement.

In some examples, the method further includes determining, by a desaturation protection circuit of the at least one solid-state fuse, a protection signal. The controller is configured to control the one or more solid-state switching devices to disconnect the one or more first components from the one or more second components based at least in part on the current slope signal and the protection signal.

In some examples, the at least one solid-state fuse comprises a plurality of solid-state fuses coupled in parallel.

In some examples, the power system is a power system of an electric vehicle.

Another example aspect of the present disclosure is directed to a solid-state fuse. The solid-state fuse includes a first power terminal operable to couple the solid-state fuse to one or more first components of a power system. The solid-state fuse further includes a second power terminal operable to couple the solid-state fuse to one or more second components of the power system. The solid-state fuse further includes one or more solid-state switching devices operable to disconnect the first power terminal from the second power terminal. The solid-state fuse further includes a bus operable to conduct at least a portion of a system current, the system current indicative of a current flowing through the power system. The solid-state fuse further includes a bus measurement circuit coupled to the bus, the bus measurement circuit configured to measure a voltage across the bus. The solid-state fuse further includes a controller. The controller is configured to determine a current slope signal indicative of a current slope of the system current based at least in part on the voltage across the bus. The controller is further configured to control the one or more solid-state switching devices to bidirectionally or unidirectionally disconnect the first power terminal from the second power terminal based at least in part on the current slope signal.

In some examples, an inductance of the bus is in a range of about 0.1 nanohenrys to about 50 nanohenrys.

In some examples, a resistance of the bus is in a range of about 0.1 microohms to about 200 microohms.

In some examples, the solid-state fuse further includes a current sensor coupled to the bus, the current sensor configured to determine a current measurement indicative of a bus current provided on the bus. The controller is configured to control the one or more solid-state switching devices to disconnect the first power terminal from the second power terminal based at least in part on the current slope signal and the current measurement.

In some examples, the bus is a copper busbar coupled to a printed circuit board (PCB), wherein the current sensor is mounted to the PCB.

In some examples, the solid-state fuse further includes a temperature sensor configured to determine a temperature measurement indicative of a temperature within the solid-state fuse. The controller is configured to control the one or more solid-state switching devices to disconnect the first power terminal from the second power terminal based at least in part on the current slope signal and the temperature measurement.

Another example aspect of the present disclosure is directed to a power system. The power system includes one or more first components. The power system further includes one or more second components. The power system further includes at least one solid-state fuse coupled between the one or more first components and the one or more second components. The at least one solid-state fuse includes a first power terminal operable to couple the solid-state fuse to the one or more first components. The at least one solid state fuse further includes a second power terminal operable to couple the solid-state fuse to the one or more second components. The at least one solid state fuse further includes one or more solid-state switching devices operable to disconnect the first power terminal from the second power terminal The at least one solid state fuse further includes a bus operable to conduct at least a portion of a system current, the system current indicative of a current flowing through the power system The at least one solid state fuse further includes a bus measurement circuit coupled to the bus, the bus measurement circuit configured to measure a voltage across the bus The at least one solid state fuse further includes a controller. The controller is configured to determine a current slope signal indicative of a current slope of the system current based at least in part on the voltage across the bus. The controller is further configured to control the one or more solid-state switching devices to bidirectionally or unidirectionally disconnect the first power terminal from the second power terminal based at least in part on the current slope.

In some examples, a resistance of the bus is in a range of about 0.1 microohms to about 200 microohms.

In some examples, the at least one solid-state fuse comprises a plurality of solid-state fuses coupled in parallel.

In some examples, the power system is a power system of an electric vehicle.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for controlling one or more solid-state switching devices of at least one solid-state fuse to disconnect one or more first components of a power system from one or more second components of the power system, the method comprising:
measuring a voltage across a bus of the at least one solid-state fuse;
determining a current slope signal indicative of a current slope of a system current flowing through the power system based at least in part on the voltage across the bus; and
controlling, by a controller of the at least one solid-state fuse, the one or more solid-state switching devices to bidirectionally or unidirectionally disconnect the one or more first components from the one or more second components of the power system based at least in part on the current slope signal.

2. The method of claim 1, wherein controlling the one or more solid-state switching devices to disconnect the one or more first components from the one or more second components comprises:
comparing, by a comparator, the current slope signal to a threshold value; and
controlling, by the controller, the one or more solid-state switching devices to disconnect the one or more first components from the one or more second components based at least in part on an output signal of the comparator.

3. The method of claim 2, wherein the controller is configured to control the one or more solid-state switching devices to disconnect the one or more first components from the one or more second components based at least in part on the output signal of the comparator over a time period.

4. The method of claim 1, wherein an inductance of the bus is in a range of about 0.1 nanohenrys to about 50 nanohenrys.

5. The method of claim 4, wherein a resistance of the bus is in a range of about 0.1 microohms to about 200 microohms.

6. The method of claim 1, further comprising:
determining, by a current sensor, a current measurement indicative of a bus current provided on the bus,
wherein the controller is configured to control the one or more solid-state switching devices to disconnect the one or more first components from the one or more second components based at least in part on the current slope signal and the current measurement.

7. The method of claim 1, further comprising:
determining, by a temperature sensor, a temperature measurement indicative of a temperature within the at least one solid-state fuse,
wherein the controller is configured to control the one or more solid-state switching devices to disconnect the one or more first components from the one or more second components based at least in part on the current slope signal and the temperature measurement.

8. The method of claim 1, further comprising:
determining, by a desaturation protection circuit of the at least one solid-state fuse, a protection signal,
wherein the controller is configured to control the one or more solid-state switching devices to disconnect the one or more first components from the one or more second components based at least in part on the current slope signal and the protection signal.

9. The method of claim 1, wherein the at least one solid-state fuse comprises a plurality of solid-state fuses coupled in parallel.

10. The method of claim 1, wherein the power system is a power system of an electric vehicle.

11. A solid-state fuse, comprising:
a first power terminal operable to couple the solid-state fuse to one or more first components of a power system;
a second power terminal operable to couple the solid-state fuse to one or more second components of the power system;
one or more solid-state switching devices operable to disconnect the first power terminal from the second power terminal;
a bus operable to conduct at least a portion of a system current, the system current indicative of a current flowing through the power system;
a bus measurement circuit coupled to the bus, the bus measurement circuit configured to measure a voltage across the bus; and
a controller configured to:
determine a current slope signal indicative of a current slope of the system current based at least in part on the voltage across the bus; and
control the one or more solid-state switching devices to bidirectionally or unidirectionally disconnect the first power terminal from the second power terminal based at least in part on the current slope signal.

12. The solid-state fuse of claim 11, wherein an inductance of the bus is in a range of about 0.1 nanohenrys to about 50 nanohenrys.

13. The solid-state fuse of claim 12, wherein a resistance of the bus is in a range of about 0.1 microohms to about 200 microohms.

14. The solid-state fuse of claim 11, further comprising:
a current sensor coupled to the bus, the current sensor configured to determine a current measurement indicative of a bus current provided on the bus,
wherein the controller is configured to control the one or more solid-state switching devices to disconnect the first power terminal from the second power terminal based at least in part on the current slope signal and the current measurement.

15. The solid-state fuse of claim 14, wherein the bus is a copper busbar coupled to a printed circuit board (PCB), wherein the current sensor is mounted to the PCB.

16. The solid-state fuse of claim 11, further comprising:
a temperature sensor configured to determine a temperature measurement indicative of a temperature within the solid-state fuse,
wherein the controller is configured to control the one or more solid-state switching devices to disconnect the first power terminal from the second power terminal based at least in part on the current slope signal and the temperature measurement.

17. A power system, comprising:
one or more first components;
one or more second components;
at least one solid-state fuse coupled between the one or more first components and the one or more second components, the at least one solid-state fuse comprising:
a first power terminal operable to couple the solid-state fuse to the one or more first components;
a second power terminal operable to couple the solid-state fuse to the one or more second components;
one or more solid-state switching devices operable to disconnect the first power terminal from the second power terminal;
a bus operable to conduct at least a portion of a system current, the system current indicative of a current flowing through the power system;
a bus measurement circuit coupled to the bus, the bus measurement circuit configured to measure a voltage across the bus; and
a controller configured to:
determine a current slope signal indicative of a current slope of the system current based at least in part on the voltage across the bus; and
control the one or more solid-state switching devices to bidirectionally or unidirectionally disconnect the first power terminal from the second power terminal based at least in part on the current slope.

18. The power system of claim 17, wherein a resistance of the bus is in a range of about 0.1 microohms to about 200 microohms.

19. The power system of claim 17, wherein the at least one solid-state fuse comprises a plurality of solid-state fuses coupled in parallel.

20. The power system of claim 17, wherein the power system is a power system of an electric vehicle.
